(19) United States
(12) Patent Application Publication
(10) Pub. No.: US 2003/0016107 A1
(43) Pub. Date: Jan. 23, 2003

(54) Circulating system for a voice coil conductor

(76) Inventor: Andrew J. Hazelton, San Carlos, CA (US)

Correspondence Address: STEVEN G. ROEDER, THE LAW OFFICE OF STEVEN G. ROEDER, 5560 Chelsea Avenue, La Jolla, CA, 92037, US

(21) Appl. No.: 09/910,228

(22) Filed: Jul. 20, 2001

(51) Int. Cl. H01F 7/08

(52) U.S. Cl. 335/220

(57) ABSTRACT

A circulating system (10) for circulating a fluid (22) from a fluid source (28) around a voice coil actuator (12) that includes a pair of spaced apart magnet arrays (32) and a conductor (36). The circulating system (10) includes a circulation housing (26) and a fluid inlet (86). The circulation housing (26) is sized and shaped to encircle at least a portion of the conductor (36) and provide a fluid passageway (54) around the conductor (36). The fluid inlet (86) extends into the fluid passageway (54) and is in fluid communication with the fluid source (28). Fluid (22) from the fluid source (28) is directed through the fluid inlet (86) into the fluid passageway (54). Preferably, the flow rate of the fluid (22) is controlled to maintain an outer surface of the actuator (12) at a set temperature to control the influence of the actuator (12) on the surrounding environment and the surrounding components. In one embodiment, the circulation housing (26) is fixedly secured to the magnet arrays (32) to minimize the influence the eddy currents.

### FIELD OF THE INVENTION

The present invention relates to a circulating system for a conductor. The invention is particularly useful for maintaining an outer surface of a voice coil actuator at a set temperature to control the influence of the voice coil actuator on the surrounding environment and the surrounding components.

### BACKGROUND

Exposure apparatuses for semiconductor processing are commonly used to transfer images from a reticle onto a semiconductor wafer. Typically, the exposure apparatus utilizes one or more actuators to precisely position a wafer stage holding the semiconductor wafer and a reticle stage retaining the reticle. Additionally, the exposure apparatus can include a vibration isolation system that includes one or more actuators. The images transferred onto the wafer from the reticle are extremely small. Accordingly, the precise positioning of the wafer and the reticle is critical to the manufacturing of the wafer. In order to obtain precise relative alignment, the position of the reticle and the wafer are constantly monitored by a measurement system. Subsequently, with the information from the measurement system, the reticle and/or wafer are moved by the one or more actuators to obtain relative alignment.

One type of actuator is a voice coil actuator. A typical voice coil actuator includes a pair of spaced apart magnet arrays that generate a magnetic field and a conductor positioned between the magnet arrays. An electrical current is directed to the conductor. The electrical current supplied to the conductor generates an electromagnetic field that interacts with the magnetic field of the magnet arrays. This causes the conductor to move relative to the magnet arrays. When the conductor is secured to one of the stages, that stage moves in concert with the conductor.

Unfortunately, the electrical current supplied to the conductor also generates heat, due to resistance in the conductor. Most voice coil actuators are not actively cooled. Thus, the heat from the conductor is subsequently transferred to the surrounding environment, including the air surrounding the actuator and the other components positioned near the actuator. The heat changes the index of refraction of the surrounding air. This reduces the accuracy of the measurement system and degrades machine positioning accuracy. Further, the heat causes expansion of the other components of the machine. This further degrades the accuracy of the machine. Moreover, the resistance of the conductor increases as temperature increases. This exacerbates the heating problem and reduces the performance and life of the actuator.

In light of the above, there is a need for a system and method for maintaining an outer surface of a voice coil actuator at a set temperature during operation. Additionally, there is a need for a system for cooling a tubular shaped conductor. Moreover, there is a need for an exposure apparatus capable of manufacturing precision devices such as high density semiconductor wafers.

### SUMMARY

The present invention is directed to a circulating system for circulating a fluid from a fluid source around a conductor component having a conductor. The present invention is also directed to an actuator combination that includes the circulating system. The circulating system includes a circulation housing and a fluid inlet. The circulation housing is sized and shaped to encircle the conductor and provide a fluid passageway near the conductor. The fluid inlet extends into the fluid passageway and is in fluid communication with the fluid source. Fluid from the fluid source is directed or forced through the fluid inlet into the fluid passageway. The conductor component is typically used as part of a non-commutated voice coil actuator that also includes a magnet component. As used herein, the term “non-commutated voice coil actuator” shall mean a short stroke electromagnetic actuator in which the current is a function of the required force only and not the relative position between the conductor and the magnet component.

Preferably, the rate of flow of the fluid to the fluid passageway is controlled by a control system to maintain an outer surface of the circulation housing at a predetermined temperature. By controlling the outer surface temperature of the circulation housing, heat transferred from the conductor to the surrounding environment can be controlled and/or eliminated. This minimizes the influence of the conductor on the surrounding environment.

A number of alternate embodiments of the circulation housing are provided herein. In a first embodiment, the circulation housing includes an outer shell and an inner shell that cooperate to define the fluid passageway. In this embodiment, each shell substantially encircles a portion of the conductor component. Alternately, in a second embodiment, the circulation housing includes an inner shell that is secured to the magnet component. In this embodiment, the inner shell cooperates with the magnet component to define the fluid passageway. Importantly, in the first and second embodiments, the circulation housing is fixedly secured to the magnet component, and the conductor component moves relative to the circulation housing. Stated another way, the circulation housing does not move relative to the magnetic fields of the magnet component. As a result of this design, the circulation housing does not generate eddy currents that could resist movement and consume energy.

In a third embodiment, the circulation housing substantially encloses the conductor. In this embodiment, the circulation housing is secured to the conductor component and the circulation housing moves with the conductor component.

The present invention is also directed to (i) an isolation system including the actuator combination, (ii) a stage assembly including the actuator combination, (iii) an exposure apparatus including the actuator combination, and (iv) an object on which an image has been formed by the exposure apparatus. Further, the present invention is also directed to (i) a method for making a circulating system, (ii) a method for making an actuator combination, (iii) a method for making a stage assembly, (iv) a method for manufacturing an exposure apparatus, and (v) a method for manufacturing an object or a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a first embodiment of an actuator combination having features of the present invention;

FIG. 2A is an exploded perspective view of a portion of the actuator combination of FIG. 1;

FIG. 2B is a cutaway view taken on line 2B-2B in FIG. 1;

FIG. 2C is a cutaway view taken on line 2C-2C in FIG. 1;

FIG. 3 is a perspective view of a second embodiment of an actuator combination having features of the present invention;

FIG. 4A is a cutaway view taken on line 4A-4A in FIG. 3;

FIG. 4B is a cutaway view taken on line 4B-4B in FIG. 3;

FIG. 5A is a perspective view of a third embodiment of an actuator combination having features of the present invention;

FIG. 5B is a perspective view of a magnet component having features of the present invention;

FIG. 5C is a perspective view of a conductor component and circulation housing having features of the present invention;

FIG. 5D is an end view of the conductor component and the circulation housing of FIG. 5C;

FIG. 5E is a side view, with hidden lines, of the conductor component and the circulation housing of FIG. 5C;

FIG. 6A is a perspective view of a conductor retainer having features of the present invention;

FIG. 6B is a side view of the conductor retainer of FIG. 6A;

FIG. 6C is a perspective view of a housing body having features of the present invention;

FIG. 6D is a perspective view of a first end cap having features of the present invention;

FIG. 6E is an end view of the first end cap of FIG. 6D;

FIG. 6F is a side view of the first end cap of FIG. 6D;

FIG. 6G is a perspective view of a second end cap having features of the present invention;

FIG. 6H is an end view of the second end cap of FIG. 6G;

FIG. 6I is a side view of the second end cap of FIG. 6G;

FIG. 7 is a schematic illustration of an exposure apparatus having features of the present invention;

FIG. 8 is a flow chart that outlines a process for manufacturing a device in accordance with the present invention; and

FIG. 9 is a flow chart that outlines device processing in more detail.

### DESCRIPTION

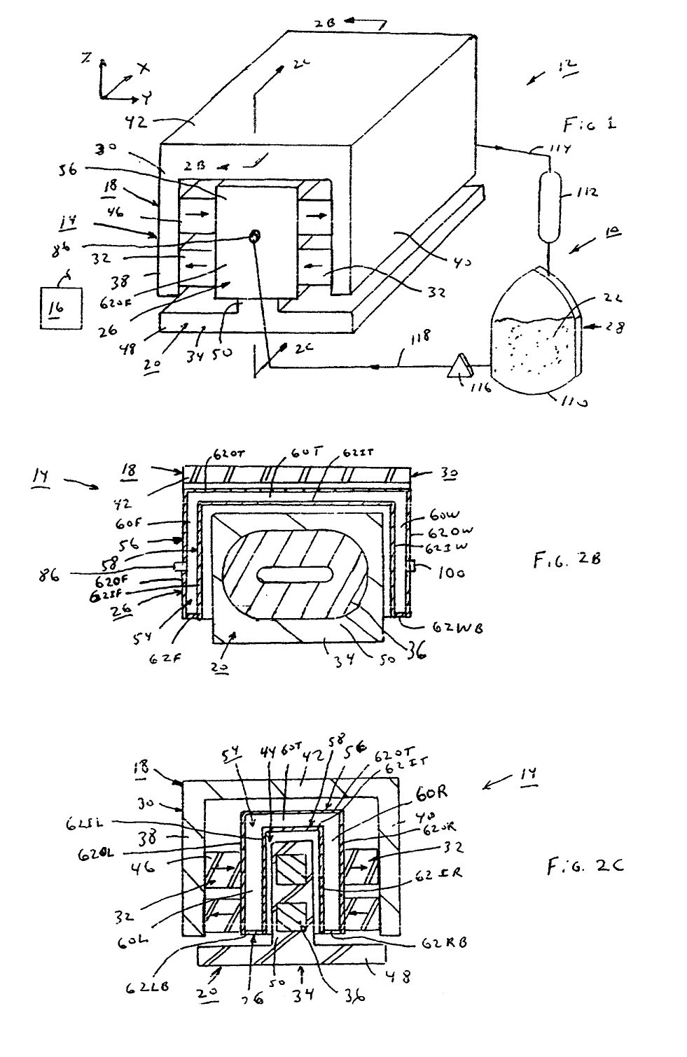

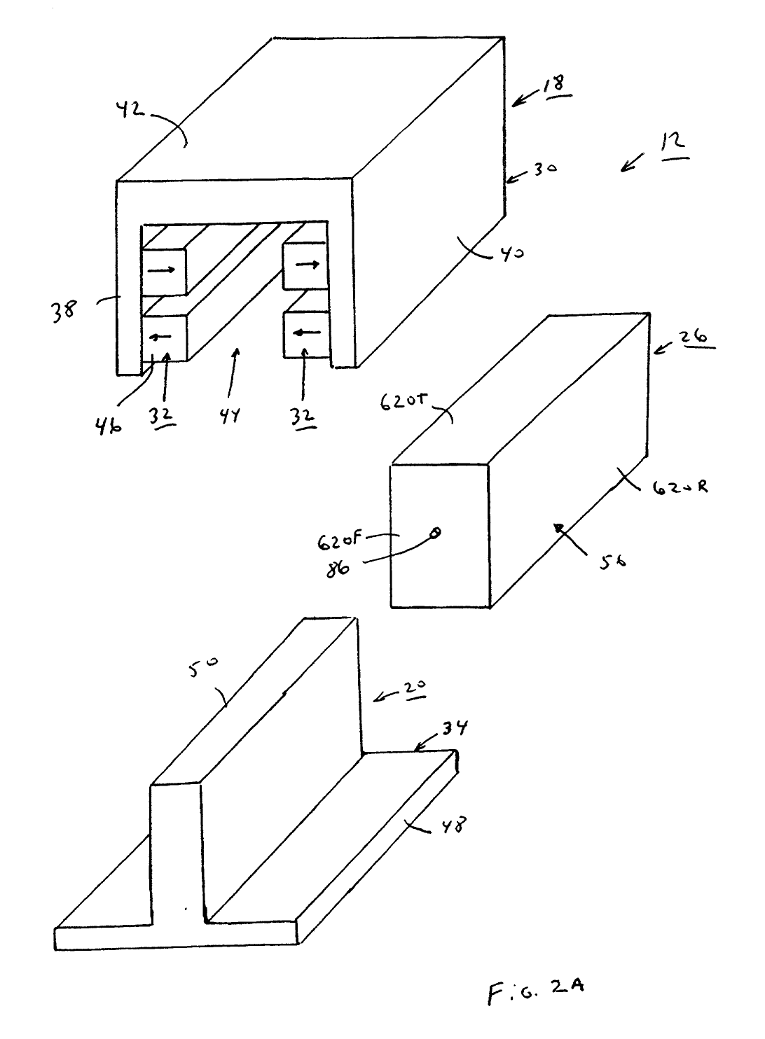

Referring initially to FIGS. 1, 2A-2C, the present invention is directed to a circulating system 10 and an actuator combination 12 that includes the circulating system 10, an actuator 14, and a control system 16. The actuator 14 includes a magnet component 18, a conductor component 20 that interacts with the magnet component 18. A number of embodiments of the actuator combination 12 are provided herein. In each embodiment, the circulating system 10 directs a circulating fluid 22 near the conductor component 20 to cool the conductor component 20. With this design, the circulating system 10 can be used to cool the area near the conductor component 20 and inhibit the transfer of heat from the conductor component 20 that surrounds the actuator 14. Stated another way, the circulating system 10 can be used to maintain the temperature of the actuator 14. This minimizes the influence of the actuator 14 on the surrounding environment and allows for more accurate positioning by the actuator 14. As an overview, in the embodiment illustrated in the Figures, the circulating system 10 includes a circulation housing 26 and a fluid source 28 of the fluid 22.

The actuator 14 is particularly useful for precisely positioning a device or machine during a manufacturing, measurement and/or an inspection process. The type of device or machine positioned and moved by the actuator 14 can be varied. Because of the circulating system 10 provided herein, the actuator combination 12 is particularly useful in manufacturing, measurement and/or inspection processes that are sensitive to and/or influenced by heat.

Some of the Figures provided herein include a coordinate system that designates an X axis, a Y axis, and a Z axis. It should be understood that the coordinate system is merely for reference and can be varied. For example, the X axis can be switched with the Y axis and/or the actuator 14 can be rotated. Additionally, some of the Figures include the symbol “+” that represents the North pole and the symbol “−” that represents the South pole of a permanent magnet.

As an overview, a number of embodiments of the actuator combination 12 are illustrated herein. In these embodiments, the actuator 14, the control system 16, and fluid source 28 are substantially the same. However, as provided in detail below, the design of the circulation housing 26 is slightly different in each of the illustrated embodiments.

The design of the actuator 14 can be varied to suit the movement requirements of the actuator 14. The actuator 14 illustrated in the Figures is typically referred to as a non-commutated voice coil actuator. For the actuator 14 illustrated in FIG. 1, the conductor component 20 is designed to move linearly along the Z axis relative to a stationary magnet component 18. Alternately, for example, the actuator 14 could be designed so that the magnet component 18 moves relative to a stationary conductor component 20. Still alternately, the present invention could be designed for use with a commutated linear motor.

The magnet component 18 includes a magnet component housing 30 and one or more magnet arrays 32, and the conductor component 20 includes a conductor component housing 34 and one or more conductors 36. The design of the magnet component housing 30 can be varied to suit the design requirements of the actuator 14. In the embodiment illustrated in the Figures, the magnet component housing 30 is somewhat “U” shaped and includes a first wall 38, a second wall 40 and a separator wall 42 that are secured together. Each of the walls 38, 40, 42 is generally planar shaped. The separator wall 42 maintains the first wall 38 spaced apart from and substantially parallel with the second wall 40. Preferably, the magnet component housing 30 is made of a magnetically permeable material, such as iron. The magnetically permeable material provides some shielding of the magnetic fields generated by the actuator 14, as well as providing a low reluctance magnetic flux return path for the magnetic fields of the magnets 46.

The number of magnet arrays 32 in the actuator 14 can be varied. For example, in the embodiment illustrated in the Figures, the actuator 14 includes a first magnet array 32 and a second magnet array 32. The first magnet array 32 is secured to the first wall 38 and the second magnet array 32 is secured to the second wall 40. The first magnet array 32 and the second magnet array 32 are spaced apart by a magnet gap 44. Alternately, for example, the actuator could be designed with a single magnet array.

Each of the magnet arrays 32 includes one or more magnets 46. The design, the positioning, and the number of magnets 46 in each magnet array 32 can be varied to suit the design requirements of the actuator 14. In the embodiment illustrated in the Figures, each magnet array 32 includes two (2), rectangular shaped magnets 46 that are aligned side-by-side and extend along the respective wall 38, 40. The two magnets 46 in each magnet array 32 are orientated so that the poles alternate between the North pole and the South pole. Stated another way, the magnets 46 in each magnet array 32 are arranged with alternating magnetic polarities. Further, the polarities of opposed magnets 46 in the two magnet arrays 32 are opposite. This leads to strong magnetic fields in the magnet gap 44 and strong force generation of the actuator 14. Stated another way, this leads to strong magnetic fields in the region of the conductor 36.

Each of the magnets 46 generates a surrounding magnetic field of preferably equal magnitude. Further, each of the magnets 46 is preferably made of a high energy product, rare earth, permanent magnetic material such as NdFeB. Alternately, for example, each magnet 46 can be made of a low energy product, ceramic magnet or other type of material that generates a magnetic field.

The design of the conductor component housing 34 can be varied to suit the design requirements of the actuator 14. In the embodiment illustrated in the FIGS. 1-4B, the conductor component housing 34 is somewhat “T” shaped and includes an attachment section 48 and a conductor section 50 that extends perpendicularly from the attachment section 48. The attachment section 48 extends across the magnet component 18 and can be used to secure the conductor component 20 to the object to be moved by the actuator 14. The conductor section 50 retains the one or more conductors 36. In the embodiment illustrated in the Figures, the conductor section 50 moves along the Z axis in the magnet gap 44 between the magnet arrays 32.

Each of the sections 48, 50 is generally rectangular shaped. Further, in the embodiment illustrated in the Figures, the attachment section 48 extends substantially horizontally along the X axis and the Y axis and the conductor section 50 extends vertically upward along the Z axis from the attachment section 48.

Typically, the conductor component 20 includes one conductor 36 that is generally annular and/or rectangular tube shaped. The conductor 36 is made of metal such as copper or any substance or material responsive to electrical current and capable of creating a magnetic field. The conductor 36 is typically made of electrical wire encapsulated in an epoxy. The conductor 36 includes (i) a left surface, (ii) a right surface, (iii) a top surface, (iv) a bottom surface, (v) a rear surface, and (v) a front surface.

It should be noted that the use of the terms top, bottom, front, back, left and right in the application is for convenience. It should be understood that these terms are merely for reference and can be varied.

In the embodiment illustrated in FIGS. 1-4B the conductor 36 is embedded into the conductor section 50 of the conductor component 20. In each embodiment illustrated in the Figures, the conductor 36 is positioned within the magnet gap 44 between the magnet arrays 32 and the conductor 36 is immersed in the magnetic fields of the magnets 46. Alternately, for example, the conductor component could include a pair of conductors that are positioned on opposite sides of a single magnet array.

The control system 16 directs and controls electrical current to the conductor 36 of the conductor component 20. The electrical current in the conductor 36 interacts with the magnetic fields that surround the magnets 46 in the magnet arrays 32. When electric current flows in the wires of the conductor 36, a Lorentz type force is generated in a direction mutually perpendicular to the direction of the wires of the conductor 36 and the magnetic field of the magnets 46. This force can be used to move one of the components 18, 20 relative to the other component 20, 18.

The circulating system 10 directs the circulating fluid 22 near the conductor 36 to cool the conductor 36. With this design, the circulating system 10 can be used to inhibit the transfer of heat from the conductor 36 to the environment that surrounds the actuator 14. Stated another way, the circulating system 10 can be used to maintain the temperature of the actuator 14. This minimizes the influence of the actuator 14 on the surrounding environment and allows for more accurate positioning by the actuator 14. The design of the circulating system 10 can be varied. As provided above, in each embodiment illustrated in the Figures, the circulating system 10 includes the circulation housing 26 and the fluid source 28 of the fluid 22.

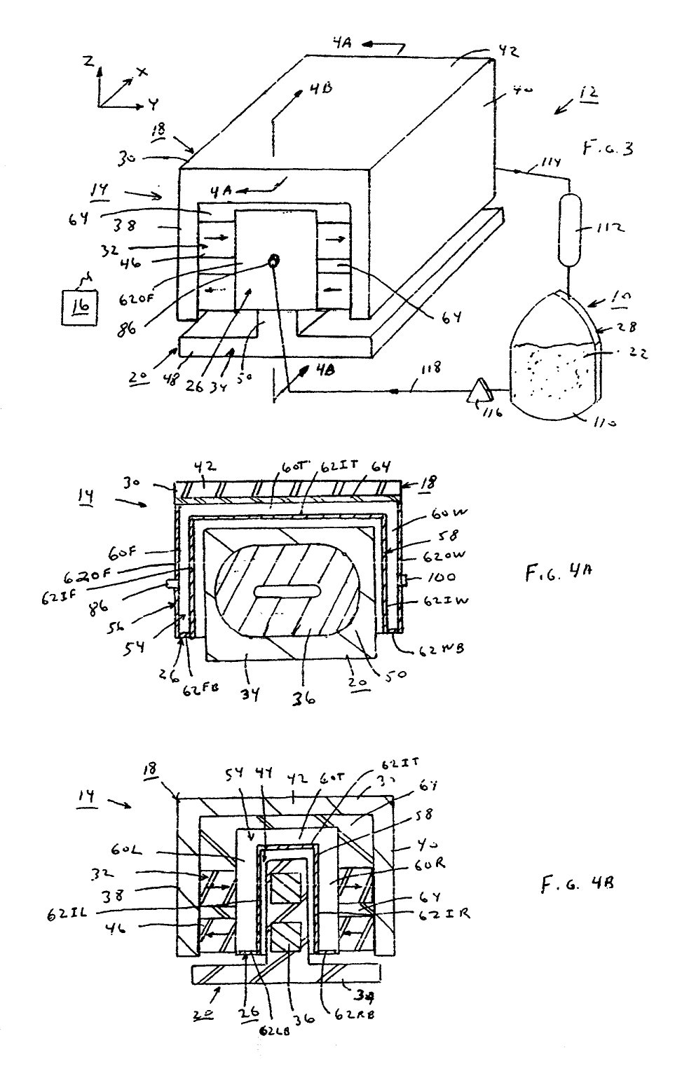

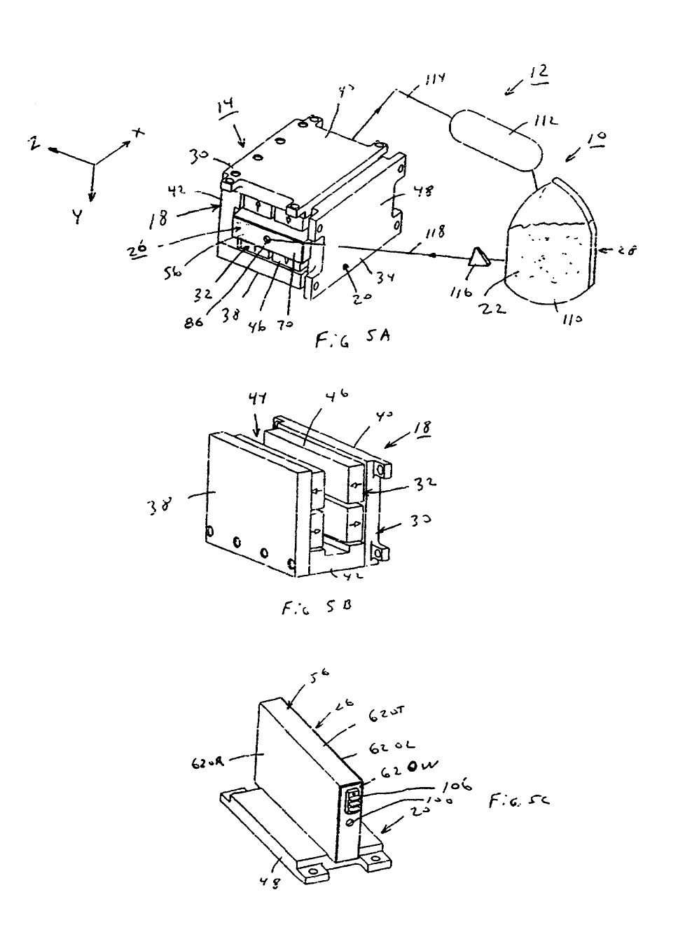

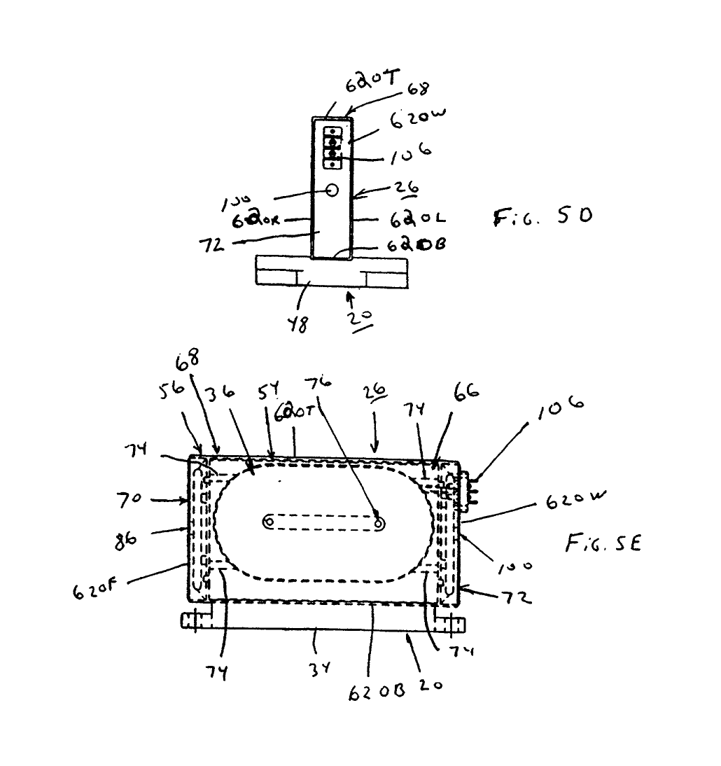

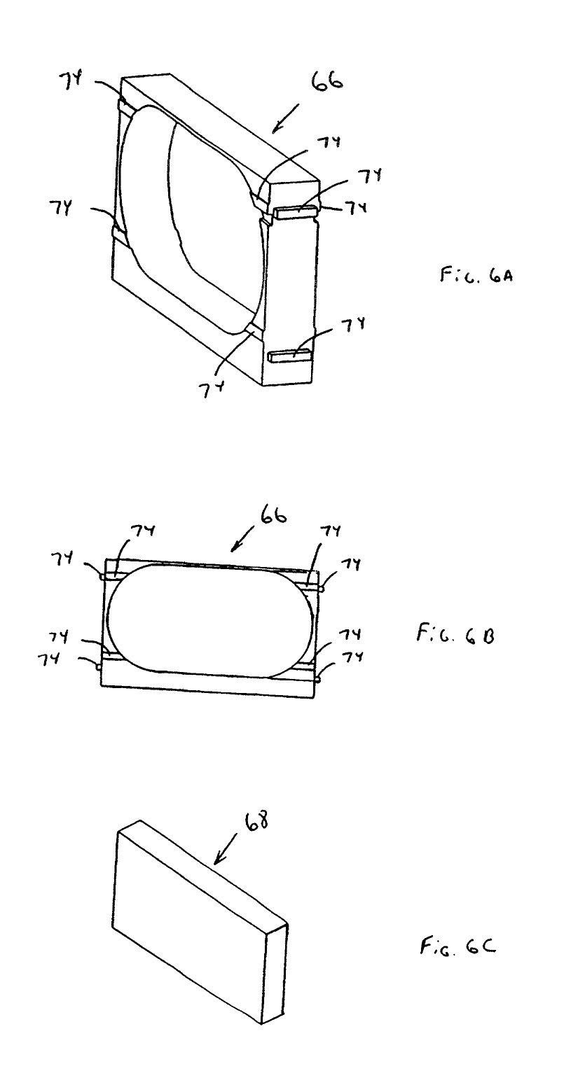

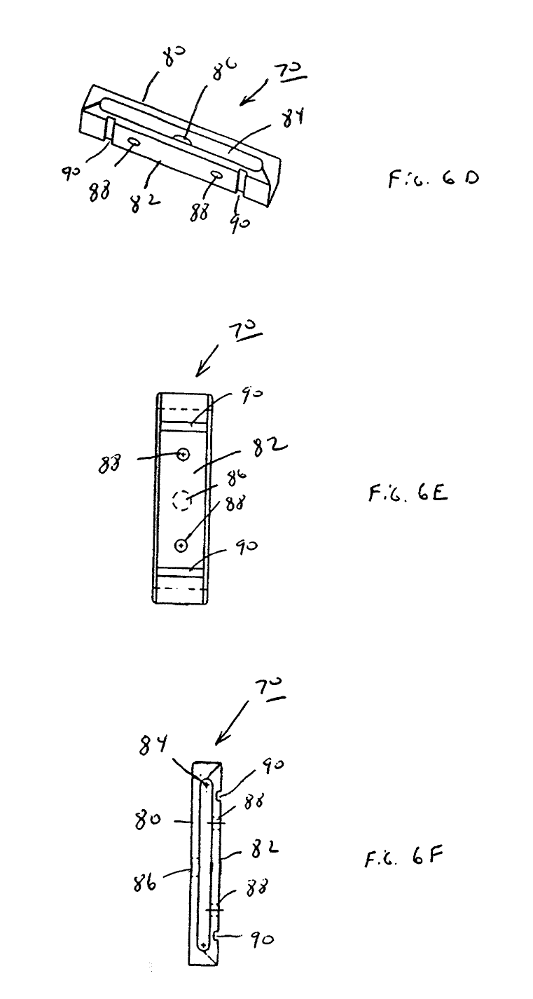

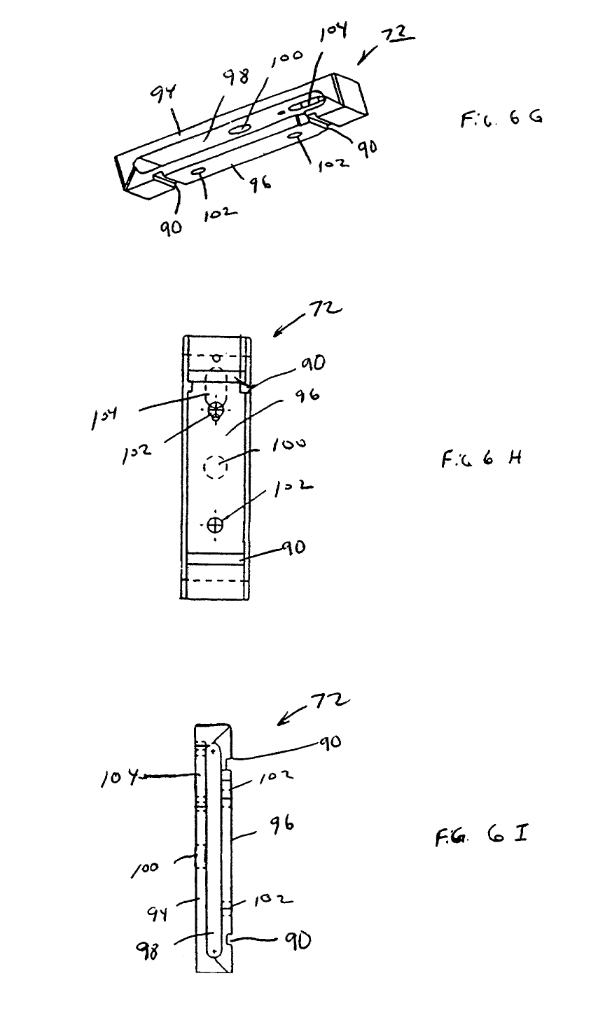

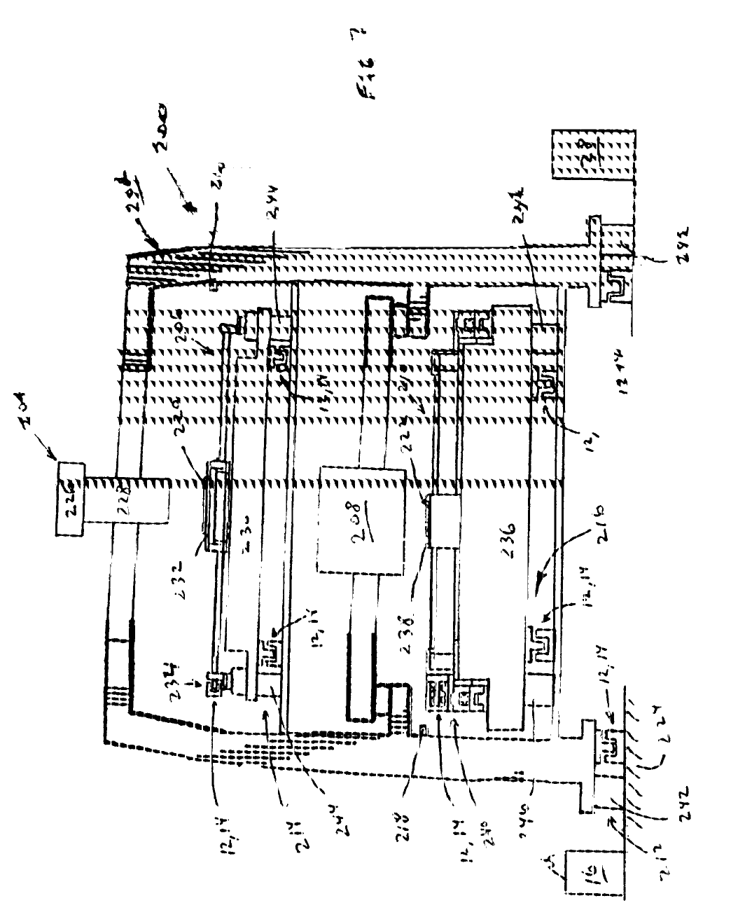

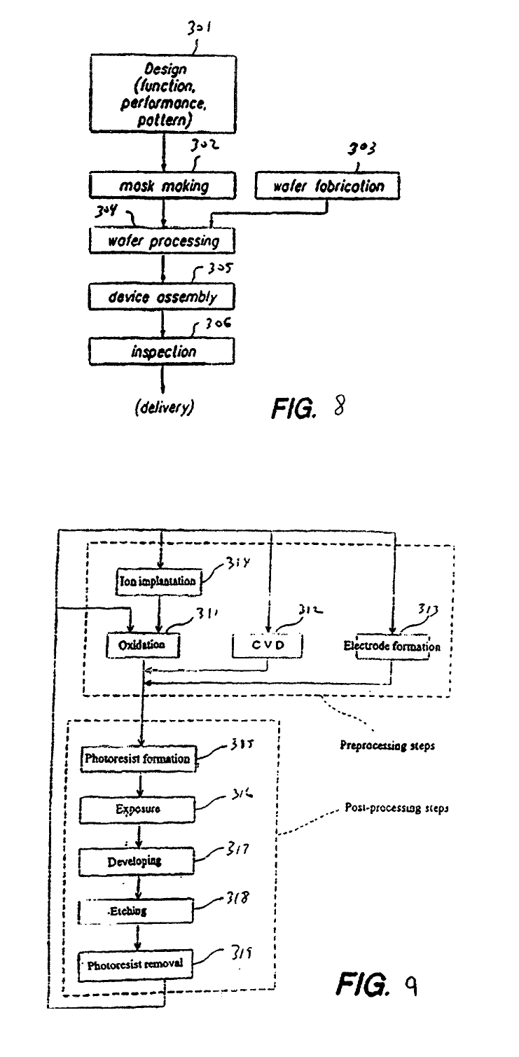

Three alternate embodiments of the circulating system 10 are illustrated in the Figures. In each embodiment, the fluid source 28 is substantially the same. In contrast, three alternate embodiments of the circulation housing 26 are illustrated in the Figures. More specifically, FIGS. 1-2C illustrate a first embodiment of the circulation housing 26, FIGS. 3-4B illustrate a second embodiment of the circulation housing 26, and FIGS. 5A-5E illustrate a third embodiment of the circulation housing 26. In each embodiment, the circulation housing 26 encircles and surrounds at least a portion of the conductor 36 and provides a fluid passageway 54 that encircles at least a portion of the conductor 36. Preferably, the fluid passageway 54 encircles substantially the entire conductor 36 so that the fluid 22 passes near the entire conductor 36.

Referring to FIGS. 1, 2A-2C, in the first embodiment, the circulation housing 26 is somewhat open box shaped. In this embodiment, the circulation housing 26 includes an outer shell 56 and an inner shell 58 that cooperate to define an open box shaped fluid passageway 54 that substantially encircles the entire conductor 36, except the conductor bottom surface. In this embodiment, each shell 56, 58 is generally open box shaped. Further, the outer shell 56 and the inner shell 58 cooperate to define the fluid passageway 54 having (i) a left channel 60L, (ii) a right channel 60R, (iii) a top channel 60T, (iv) a rear channel 60W, and (v) a front channel 60F. It should be noted that each of the channels of the fluid passageway 54 are positioned near the corresponding surface of the conductor 36. Further, each channel has a width of between approximately 0.2 and 5 mm.

More specifically, in the embodiment in FIGS. 1, 2A-2C, the circulation housing 26 includes (i) an outer top side 62OT; (ii) an inner top side 62IT that is positioned near and substantially parallel to the outer top side 62OT; (iii) an outer left side 62OL that extends perpendicularly downward from the outer top side 62OT; (iv) an inner left side 62IL that is positioned near and substantially parallel to the outer left side 62OL; the inner left side 62IL extends perpendicularly downward from the inner top side 62IT; (v) an outer right side 62OR that extends perpendicularly downward from the outer top side 62OT, the outer right side 62OR being substantially parallel with and spaced apart from the outer left side 62OL and the inner left side 62IL; (vi) an inner right side 62IR that is positioned near and substantially parallel to the outer right side 62OR, the inner right side 62IR extends perpendicularly downward from the inner top side 62IT; (vii) an outer rear side 62OW that extends perpendicularly downward from the outer top side 62OT, the outer rear side 62OW extending between the outer right side 62OR and the outer left side 62OL; (viii) an inner rear side 62IW that extends perpendicularly downward from the inner top side 62IT near and substantially parallel to the outer rear side 62OW, the inner rear side 62IW extending between the inner right side 62IR and the inner left side 62IL; (ix) an outer front side 62OF that extends perpendicularly downward from the outer top side 62OT, the outer front side 62OF extending between the outer right side 62OR and the outer left side 62OL, the outer front side 62OF being substantially parallel to and spaced apart from the outer rear side 62OW and the inner rear side 62IW; (x) an inner front side 62IF that extends perpendicularly downward from the inner top side 62IT near and substantially parallel to the outer front side 62OF, the inner front side 62IF extending between the inner right side 62IR and the inner left side 62IL; (xi) a left bottom side 62LB that extends perpendicularly between the outer left side 62OL and the inner left side 62IL; (xii) a right bottom side 62RB that extends perpendicularly between the outer right side 62OR and the inner right side 62IR; (xiii) a rear bottom side 62WB that extends perpendicularly between the outer rear side 62OW and the inner rear side 62IW; and (xiv) a front bottom side 62FB that extends perpendicularly between the outer front side 62OF and the inner front side 62IF. In this embodiment, each of the sides is generally flat plate shaped.

The circulation housing 26 is preferably made of a low or non-electrically conductive, non-magnetic material, such as low electrical conductivity stainless steel or titanium, or non-electrically conductive plastic or ceramic.

Importantly, in the embodiment illustrated in FIGS. 1, 2A-2C, the circulation housing 26 is fixedly secured to the magnet component 18 and the conductor component 20 moves relative to the circulation housing 26. Stated another way, the circulation housing 26 does not move relative to the magnetic fields of the magnet component 18. As a result of this design, the circulation housing 26 does not generate eddy currents that could resist movement and consume energy. In contrast, if the circulation housing was made from a conductive material and moved relative to the magnet component 18, the movement of the circulation housing would generate eddy currents that resist movement and consume energy.

Further, in this embodiment, because the circulation housing 26 is stationary, there is no energy consumption or vibration caused by the flexing of the hoses used in the fluid source 28.

Referring to FIGS. 3-4B, in the second embodiment, the circulation housing 26 includes the inner shell 58 that cooperates with the magnet component 18 to define an open box shaped fluid passageway 54 that substantially encircles the entire conductor 36, except the conductor bottom surface. In this embodiment, the inner shell 58 and the magnet component 18 cooperate to define the fluid passageway 54 having (i) the left channel 60L, (ii) the right channel 60R, (iii) the top channel 60T, (iv) the rear channel 60W, and (v) the front channel 60F. It should be noted that each of the channels of the fluid passageway 54 are positioned near the corresponding surface of the conductor 36. Preferably, the space between the magnets 46 in each magnet array 32 is filled with a filler 64 to reduce the size of the fluid passageway 54. The filler 64 can be an epoxy. Alternately, for example, the filler 64 can be any other type of adhesive or material.

More specifically, in the embodiment illustrated in FIGS. 3-4B, the circulation housing 26 includes (i) the inner top side 62IT; (ii) the inner left side 62IL that extends perpendicularly downward from the inner top side 62IT; (iii) the inner right side 62IR that extends perpendicularly downward from the inner top side 62IT; (iv) the outer rear side 62OW that extends perpendicularly downward between the magnet arrays 32; (v) the inner rear side 62IW that extends perpendicularly downward from the inner top side 62IT between the inner right side 62IR and the inner left side 62IL; (vi) the outer front side 62OF that extends perpendicularly downward between the magnet arrays 32; (vii) the inner front side 62IF that extends perpendicularly downward from the inner top side 62IT extending between the inner right side 62IR and the inner left side 62IL; (viii) the left bottom side 62LB that extends perpendicularly between the first magnet array 32 and the inner left side 62IL; (ix) the right bottom side 62RB that extends perpendicularly between the second magnet array 32 and the inner right side 62IR; (x) the rear bottom side 62WB that extends perpendicularly between the outer rear side 62OW and the inner rear side 62IW; and (xi) the front bottom side 62FB that extends perpendicularly between the outer front side 62OF and the inner front side 62IF. In this embodiment, each of the sides is again generally flat plate shaped.

Again, in this embodiment, the circulation housing 26 is preferably made of a low or non-electrically conductive, non-magnetic material, such as low electrical conductivity stainless steel or titanium, or non-electrically conductive plastic or ceramic. Further, in the embodiment illustrated in FIGS. 3-4B, the circulation housing 26 is fixedly secured to the magnet component 18 and the conductor component 20 moves relative to the circulation housing 26. Thus, the circulation housing 26 does not move relative to the magnetic fields of the magnet component 18. Additionally, in this embodiment, because the circulation housing 26 is stationary, there is no energy consumption or vibration caused by the flexing of the hoses used in the fluid source 28.

Referring to FIGS. 5A-5E, in the third embodiment, the circulation housing 26 is somewhat rectangular box shaped and includes the outer shell 56 that encircles the conductor 36. Stated another way, the circulation housing 26 surrounds the entire conductor 36 and provides the fluid passageway 54 between the circulation housing 26 and the conductor 36. In this embodiment, the fluid passageway 54 encircles and encloses the entire conductor 36 so that the fluid 22 passes over and contacts substantially the entire conductor 36.

More specifically, in this embodiment, the circulation housing 26 includes (i) the outer top side 62OT; (ii) the outer left side 62OL that extends perpendicularly downward from the outer top side 62OT; (iii) the outer right side 62OR that extends perpendicularly downward from the outer top side 62OT, the outer right side 62OR being substantially parallel with and spaced apart from the outer left side 62OL; (iv) the outer rear side 62OW that extends perpendicularly downward from the outer top side 62OT between the outer right side 62OR and the outer left side 62OL; (v) the outer front side 62OF that extends perpendicularly downward from the outer top side 62OT between the outer right side 62OR and the outer left side 62OL; and (vi) an outer bottom side 62OB that extends perpendicularly between the outer left side 62OL, the outer right side 62OR, the outer rear side 62OL, the outer right side 62OF. The outer bottom side 62OB is fixedly secured to the attachment section 48 of the conductor component 20.

The circulation housing 26 in this embodiment is formed with a conductor retainer 66, a housing body 68, a front end cap 70 and a rear end cap 72. Referring to FIGS. 6A and 6B, the conductor retainer 66 retains the conductor 36 and maintains the conductor 36 spaced apart from the circulation housing 26. In FIGS. 6A and 6B, the conductor retainer 66 is generally rectangular shaped and includes an oval shaped opening that receives the conductor 36. The conductor retainer 66 is preferably made from a non-electrically conductive, non-magnetic material, such as low electrical conductivity stainless steel or titanium, or non-electrically conductive plastic or ceramic.

Preferably, in this embodiment, the circulating system 10 includes one or more supports 74 that support the conductor 36 and the conductor retainer 66 spaced apart from the circulation housing 26. This reduces heat transfer between the conductor 36 and the circulation housing 26 and helps to define the fluid passageway 54. In the embodiment illustrated in FIGS. 6A-B, the circulating system 10 includes twelve supports 74 that are formed into the conductor retainer 66 and extend outwardly from the conductor retainer 66. More specifically, in this embodiment, each side of the conductor retainer 66 includes four spaced apart supports 74 and each end of the conductor retainer 66 includes two spaced apart supports 74. Further, a mandrel 76 is positioned in the center of the conductor 36. The mandrel 76 is slightly wider than the conductor 36 and acts as a support to maintain the circulation housing 26 spaced apart from the conductor 36.

The distance in which the supports 74 maintain the conductor 36 spaced apart from the circulation housing 26 is preferably between approximately 0.1 mm and 5 mm. Importantly, the supports 74 provide the fluid passageway 54 between the conductor 36 and the circulation housing 26 and allow for flow of the fluid 22 to circulate around substantially the entire exposed surface area of the conductor 36. Alternately, for example, the supports 74 can be attached to the circulation housing 26.

It should be noted that during use, the fluid pressure in the fluid passageway causes the sides of the circulation housing 26 to bend away from the supports 74 on the sides of the conductor retainer 66. Preferably, the supports are not connected to the housing, resulting in a gap between the supports and the housing. This minimizes direct thermal contact between the circulation housing 26 and the conductor 36, minimizes the heat transfer from the conductor 36 to the circulation housing 26 and maximizes the area of the conductor 36 that is exposed for cooling with the fluid 22.

Referring to FIG. 6C, the housing body 68 is a generally rectangular tube shaped structure that encircles the conductor retainer 66, the conductor 36, and each end cap 70, 72. The front end cap 70 distributes the fluid around the conductor 36. Referring to FIGS. 6D-6F, the front end cap 70 includes an outer wall 80, an inner wall 82 and an oval shaped cavity 84 that extends transversely between the walls 80, 82. A fluid inlet 86 extends through the outer wall 80 into the cavity 84. The width of the inner wall 82 is less than the width of the outer wall 80. Further, the inner wall 82 includes a pair of wall apertures 88. With this design, the fluid 22 entering through the fluid inlet 86 is forced into the cavity 84 and distributed along all of the surfaces of the conductor 36. This reduces the likelihood of localized hot areas.

Additionally, the inner wall 82 includes a pair of spaced apart slots 90 for receiving the supports 74 from one of the ends of the conductor retainer 66. Importantly, the depth of the slots 90 is less than the length of the supports 74 so that the conductor retainer 66 and the conductor 36 are maintained spaced apart from the circulation housing 26.

Somewhat similarly, referring to FIGS. 6G-6I, the rear end cap 72 includes an outer wall 94, an inner wall 96 and an oval shaped cavity 98 that extends transversely between the walls 94, 96. A fluid outlet 100 extends from the cavity 98 through the outer wall 94. The width of the inner wall 96 is less than the width of the outer wall 94. Further, the inner wall 96 includes a pair of wall apertures 102.

Further, the inner wall 96 includes a pair of spaced apart slots 90 for receiving the supports 74 from one of the ends of the conductor retainer 66. The depth of the slots 90 is less than the length of the supports 74 so that the conductor retainer 66 and the conductor 36 are maintained spaced apart from the circulation housing 26.

Additionally, in this embodiment, the circulation housing 26 includes a connector aperture 104 that receives an electrical connector 106 for electrically connecting the conductor 36 to the control system 16. The connector aperture 104 is preferably in the rear end cap 72 to minimize the disturbance of fluid flow in the fluid passageways 54.

It should be noted that in this embodiment, the circulation housing 26, can be easily assembled by (i) positioning the conductor 36 in the conductor retainer 66, (ii) positioning the mandrel 76 in the conductor 36, (iii) coupling thee end caps 70, 72 to the conductor retainer 66, (iv) sliding the housing body 68 around the end caps 70, 72, the conductor retainer 66 and the conductor 36, and (v) securing, e.g. by welding, the housing body 68 to the end caps 70, 72.

In each embodiment, the circulation housing 26 includes (i) the fluid inlet 86 that allows for the flow of fluid 22 from the fluid source 28 into the fluid passageway 54 and (ii) the fluid outlet 100 that allows for the flow of fluid 22 from the fluid passageway 54 to the fluid source 28. The location of the fluid inlet 86 and fluid outlet 100 can be varied to influence the cooling of the actuator 14. In the embodiment illustrated in FIGS. 1 and 3, (i) the fluid inlet 86 is an aperture in the outer front side 62OF of the circulation housing 26 that extends into the fluid passageway 54 and (ii) the fluid outlet 100 is an aperture in the outer rear side 62OW of the circulation housing 26 that extends into the fluid passageway 54. Alternately, for example, the single fluid inlet 86 and the single fluid outlet 100, illustrated in the Figures, can be replaced by multiple fluid inlets and multiple fluid outlets.

The fluid source 28 forces or directs the fluid 22 through the fluid passageway 54 to cool the conductor 36. The design of the fluid source 28 can be varied to suit the cooling requirements of the conductor 36. Referring to FIGS. 1, 3 and 5A, the fluid source 28 illustrated includes (i) a reservoir 110 for receiving the fluid 22, (ii) a heat exchanger 112, i.e. a chiller unit, for cooling the fluid 22, (iv) an outlet pipe 114 which connects the fluid outlet 100 with the heat exchanger 112, (v) a fluid pump 116, and (vi) an inlet pipe 118 for transferring the fluid 22 from the fluid pump 116 to the fluid inlet 86. The fluid source is commercially available from Noah Precision, San Jose Calif.

The temperature, flow rate, and type of the fluid 22 is selected and controlled by the control system 16 to precisely control the temperature of the conductor 22. For the embodiments illustrated, the fluid temperature is maintained between approximately 20 and 25° C. and the flow rate is between approximately one and five liters per minute. A suitable fluid 22 is Flourinert type FC-77, made by 3M Company in Minneapolis, Minn. Preferably, the rate of flow of the fluid 22 and the temperature of fluid 22 is controlled by the control system 16 to maintain an outer surface of the actuator 14 and/or the circulating housing 26 at a predetermined temperature. By controlling the temperature of the outer surface of the actuator 14, heat transferred from the conductor 36 to the surrounding environment is minimized.

FIG. 7 is a schematic view illustrating an exposure apparatus 200 useful with the present invention. The exposure apparatus 200 includes the apparatus frame 202, an illumination system 204 (irradiation apparatus), a reticle stage assembly 206, the optical assembly 208 (lens assembly), a wafer stage assembly 210, a frame isolation system 212, a reticle stage isolation system 214, a wafer stage isolation system 216, and a measurement system 218. The actuator combination 12 provided herein can be used in the reticle stage assembly 206, the wafer stage assembly 210, the frame isolation system 212, the reticle stage isolation system 214 and the wafer stage isolation system 216.

Importantly, as provided herein, the actuator combination 12 effectively does not transfer heat to the surrounding environment. Thus, with the present design, the actuator 14 could be placed closer to the measurement system 218. Because, the actuator 14 can be placed closer to the measurement system, the actuator 14 can be integrated into one or both of the stage assemblies 206, 210 and the size of the stage assemblies 206, 210 can be reduced. As a result thereof, smaller actuators 14 can be used and the actuators 14 can more accurately position the object. Further, the exposure apparatus 200 is capable of manufacturing higher precision devices, such as higher density, semiconductor wafers.

The exposure apparatus 200 is particularly useful as a lithographic device that transfers a pattern (not shown) of an integrated circuit from a reticle 220 onto a device such as a semiconductor wafer 222. The exposure apparatus 200 mounts to a mounting base 224, e.g., the ground, a base, or floor or some other supporting structure.

The apparatus frame 202 is rigid and supports the components of the exposure apparatus 200. The design of the apparatus frame 202 can be varied to suit the design requirements for the rest of the exposure apparatus 200. The apparatus frame 202 illustrated in FIG. 7 supports the optical assembly 208 and the illumination system 204, the reticle stage assembly 206, and the wafer stage assembly 208 above the mounting base 224.

The illumination system 204 includes an illumination source 226 and an illumination optical assembly 228. The illumination source 226 emits a beam (irradiation) of light energy. The illumination optical assembly 228 guides the beam of light energy from the illumination source 226 to the optical assembly 208. The beam illuminates selectively different portions of the reticle 220 and exposes the semiconductor wafer 222. In FIG. 7, the illumination source 226 is illustrated as being supported above the reticle stage assembly 206. Typically, however, the illumination source 226 is secured to one of the sides of the apparatus frame 202 and the energy beam from the illumination source 226 is directed to above the reticle stage assembly 206 with the illumination optical assembly 228.

The optical assembly 208 projects and/or focuses the light passing through the reticle to the wafer. Depending upon the design of the exposure apparatus 200, the optical assembly 208 can magnify or reduce the image illuminated on the reticle.

The reticle stage assembly 206 holds and positions the reticle 220 relative to the optical assembly 208 and the wafer 222. The reticle stage assembly 206 typically includes a reticle stage base 230, a reticle stage 232 that retains the reticle 220, and a reticle stage mover assembly 234 that moves the reticle stage 232 relative to the wafer 222. In FIG. 7, the reticle stage mover assembly 234 utilizes an actuator combination 12 having features of the present invention. Depending upon the design, the reticle stage mover assembly 234 can also include additional actuators and motor that move the reticle stage 232.

Somewhat similarly, the wafer stage assembly 210 holds and positions the wafer 222 with respect to the projected image of the illuminated portions of the reticle 220 in the operational area. The wafer stage assembly 210 holds and positions the wafer 222 relative to the optical assembly 208. The wafer stage assembly 210 typically includes a wafer stage base 236, a wafer stage 238 that retains the wafer 222, and a wafer stage mover assembly 240 that moves the wafer stage 238. In FIG. 7, the wafer stage mover assembly 240 utilizes an actuator combination 12 having features of the present invention. Depending upon the design, the wafer stage mover assembly 240 can also include additional actuators and motors that move the wafer stage 238.

The frame isolation system 212 secures the apparatus frame 202 to the mounting base 224 and reduces the effect of vibration of the mounting base 224 causing vibration to the apparatus frame 202. In this embodiment, the frame isolation system 212 includes (i) a plurality of pneumatic cylinders 242 that isolate vibration, and (ii) actuators combinations 12 made pursuant to the present invention that isolate vibration and control the position of the apparatus frame 202 relative to the mounting base 224. The reticle stage isolation system 214 secures and supports the reticle stage base 230 to the apparatus frame 202 and reduces the effect of vibration of the apparatus frame 202 causing vibration to the reticle stage base 230. In this embodiment, the reticle isolation system 214 includes (i) a plurality of pneumatic cylinders 244 that isolate vibration, and (ii) actuators combinations 12 made pursuant to the present invention that isolate vibration and control the position of the reticle stage base 230 relative to the apparatus frame 202.

The wafer stage isolation system 216 secures and supports the wafer stage base 236 to the apparatus frame 202 and reduces the effect of vibration of the apparatus frame 202 causing vibration to the wafer stage base 236. In this embodiment, the wafer stage isolation system 216 includes (i) a plurality of pneumatic cylinders 246 that isolate vibration, and (ii) actuators combinations 12 made pursuant to the present invention that isolate vibration and control the position of the wafer stage base 236 relative to the apparatus frame 202.

The measurement system 218 monitors movement of the reticle stage 232 and the wafer stage 238 relative to the optical assembly 208. The design of the measurement system 218 can be varied. For example, the measurement system 218 can utilize laser interferometers, encoders, and/or other measuring devices to monitor the position of the reticle stage 232 and the wafer stage 238.

There are a number of different types of lithographic devices. For example, the exposure apparatus 200 can be used as scanning type photolithography system that exposes the pattern from the reticle onto the wafer with the reticle and the wafer moving synchronously. In a scanning type lithographic device, the reticle is moved perpendicular to an optical axis of the optical assembly 208 by the reticle stage assembly 206 and the wafer is moved perpendicular to an optical axis of the optical assembly 208 by the wafer stage assembly 210. Scanning of the reticle and the wafer occurs while the reticle and the wafer are moving synchronously.

Alternately, the exposure apparatus 200 can be a step-and-repeat type photolithography system that exposes the reticle while the reticle and the wafer are stationary. In the step and repeat process, the wafer is in a constant position relative to the reticle and the optical assembly 208 during the exposure of an individual field. Subsequently, between consecutive exposure steps, the wafer is consecutively moved by the wafer stage perpendicular to the optical axis of the optical assembly 208 so that the next field of the wafer is brought into position relative to the optical assembly 208 and the reticle for exposure. Following this process, the images on the reticle are sequentially exposed onto the fields of the wafer so that the next field of the wafer is brought into position relative to the optical assembly 208 and the reticle.

However, the use of the exposure apparatus 200 provided herein is not limited to a photolithography system for semiconductor manufacturing. The exposure apparatus 200, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the actuator combination 12 provided herein can be used in other devices, including other semiconductor processing equipment, elevators, electric razors, machine tools, metal cutting machines, inspection machines and disk drives.

The illumination source 226 can be g-line (436 nm), i-line (365 nm), KrF excimer laser (248 nm), ArF excimer laser (193 nm) and F₂ laser (157 nm). Alternately, the illumination source 226 can also use charged particle beams such as an x-ray and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

In terms of the magnification of the optical assembly 208 included in the photolithography system, the optical assembly 208 need not be limited to a reduction system. It could also be a 1× or magnification system.

With respect to a optical assembly 208, when far ultra-violet rays such as the excimer laser is used, glass materials such as quartz and fluorite that transmit far ultra-violet rays is preferable to be used. When the F₂ type laser or x-ray is used, the optical assembly 208 should preferably be either catadioptric or refractive (a reticle should also preferably be a reflective type), and when an electron beam is used, electron optics should preferably consist of electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. Patent Application No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

Further, in photolithography systems, when linear motors (see U.S. Pat. Nos. 5,623,853 or 5,528,100) are used in a wafer stage or a mask stage, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,100 are incorporated herein by reference.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically released to the floor (ground) by use of a frame member as described in U.S. Pat. No. 5,528,100 and published Japanese Patent Application Disclosure No. 8-136475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,100 and 5,874,820 and Japanese Patent Application Disclosure No. 8-330224 are incorporated herein by reference.

As described above, a photolithography system (an exposure apparatus) according to the above described embodiments can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

Further, semiconductor devices can be fabricated using the above described systems, by the process shown generally in FIG. 8. In step 301 the device's function and performance characteristics are designed. Next, in step 302, a mask (reticle) having a pattern is designed according to the previous designing step, and in a parallel step 303 a wafer is made from a silicon material. The mask pattern designed in step 302 is exposed onto the wafer from step 303 in step 304 by a photolithography system described hereinabove in accordance with the present invention. In step 305 the semiconductor device is assembled (including the dicing process, bonding process and packaging process), finally, the device is then inspected in step 306.

FIG. 9 illustrates a detailed flowchart example of the above-mentioned step 304 in the case of fabricating semiconductor devices. In FIG. 9, in step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above mentioned steps 311-314 form the preprocessing steps for wafers during wafer processing, and selection is made at each step according to processing requirements. At each stage of wafer processing, when the above-mentioned preprocessing steps have been completed, the following post-processing steps are implemented. During post-processing, first, in step 315 (photoresist formation step), photoresist is applied to a wafer. Next, in step 316 (exposure step), the above-mentioned exposure device is used to transfer the circuit pattern of a mask (reticle) to a wafer. Then in step 317 (developing step), the exposed wafer is developed, and in step 318 (etching step), parts other than residual photoresist (exposed material surface) are removed by etching. In step 319 (photoresist removal step), unnecessary photoresist remaining after etching is removed.

Multiple circuit patterns are formed by repetition of these preprocessing and post-processing steps.

Importantly, with the present invention, the circulating system 10 maintains the outer surface of each actuator 14 at a set temperature. This minimizes the effect of the actuators 12 on the temperature of the surrounding environment. This also allows the measurement system 218 to take accurate measurements of the position of the stages 232, 238. As a result thereof, the quality of the integrated circuits formed on the wafer 222 is improved.

While the particular actuator 14 and circulating system 10 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A circulating system for circulating a fluid from a fluid source near an actuator, the actuator having a magnet component and a conductor component, the circulating system comprising:
a circulation housing that is coupled to the magnet component, the circulation housing providing a fluid passageway near the conductor component; and
a fluid inlet into the fluid passageway, the fluid inlet being in fluid communication with the fluid source so that fluid from the fluid source is supplied to the fluid passageway.

2. The circulating system of claim 1 wherein the circulation housing includes an outer shell and an inner shell that cooperate to define the fluid passageway.

3. The circulating system of claim 2 wherein each shell substantially encircles the conductor component.

4. The circulating system of claim 1 wherein the circulation housing includes an inner shell that is secured to the magnet component, the inner shell cooperating with the magnet component to define the fluid passageway.

5. The circulating system of claim 1 wherein the circulation housing substantially encircles the conductor component and the circulation housing directs the fluid around the conductor component.

6. The circulating system of claim 1 further comprising a control system that controls the flow of the fluid from the fluid source to the circulation housing to inhibit the transfer of heat from the conductor component to the environment surrounding the actuator.

7. The circulating system of claim 1 wherein the fluid is used to cool the environment surrounding the conductor component.

8. An actuator combination including an actuator and the circulating system of claim 1.

9. The actuator combination of claim 8 wherein the actuator includes a magnet component and a conductor component, and wherein the circulation housing is secured to the magnet component.

10. The actuator combination of claim 9 wherein the magnet component includes a pair of spaced apart magnet arrays and the conductor component includes a conductor positioned between the magnet arrays.

11. An isolation system including the actuator combination of claim 8.

12. A stage assembly including the actuator combination of claim 8.

13. An exposure apparatus including the actuator combination of claim 8.

14. An object on which an image has been formed by the exposure apparatus of claim 13.

15. A semiconductor wafer on which an image has been formed by the exposure apparatus of claim 13.

16. A circulating system for circulating a fluid from a fluid source near an actuator, the actuator having a magnet component and a conductor component, the circulating system comprising:
a circulation housing that is positioned near the conductor component, the circulation housing providing a fluid passageway that substantially encircles a portion of the conductor component, the circulation housing including an end cap that distributes the fluid around the conductor component; and
a fluid inlet into the end cap, the fluid inlet being in fluid communication with the fluid source so that fluid from the fluid source is supplied to the fluid end cap.

17. The circulating system of claim 16 wherein the end cap includes an outer wall, an inner wall and a cavity between the outer wall and the inner wall, the inner wall having a width that is less than a width of the outer wall.

18. The circulating system of claim 16 wherein the circulation housing includes an outer shell that encircles the conductor component.

19. The circulating system of claim 18 wherein the outer shell encircles the end cap.

20. The circulating system of claim 16 wherein the circulation housing includes a conductor housing that encircles and retains the conductor component and an outer shell that encircles the conductor component.

21. The circulating system of claim 20 wherein the outer shell encircles the conductor housing.

22. The circulating system of claim 21 wherein the circulation housing includes a plurality of supports that extend between the outer shell and the conductor housing to define the fluid passageway between the outer shell and the conductor housing.

23. The circulating system of claim 21 wherein the circulation housing includes a support that extends between the conductor housing and the end cap, the support coupling the conductor housing to the end cap.

23. The circulating system of claim 21 wherein fluid in the fluid passageway causes the outer shell to expand away from the conductor housing.

24. The circulating system of claim 16 further comprising a control system that controls the flow of the fluid from the fluid source to the circulation housing to inhibit the transfer of heat from the conductor component to the environment surrounding the actuator.

25. The circulating system of claim 16 wherein the fluid is used to cool the environment surrounding the conductor component.

26. An actuator combination including an actuator and the circulating system of claim 16.

27. The actuator combination of claim 26 wherein the actuator includes a magnet component having a pair of spaced apart magnet arrays and a conductor component having a conductor positioned between the magnet arrays.

28. An isolation system including the actuator combination of claim 26.

29. A stage assembly including the actuator combination of claim 26.

30. An exposure apparatus including the actuator combination of claim 26.

31. An object on which an image has been formed by the exposure apparatus of claim 30.

32. A semiconductor wafer on which an image has been formed by the exposure apparatus of claim 30.

33. An actuator combination for use with a fluid source including a fluid, the actuator combination comprising:
a magnet component;
a conductor component including a conductor;
a circulation housing that provides a fluid passageway near the conductor, the circulation housing being fixedly secured to the magnet component; and
a fluid inlet into the fluid passageway, the fluid inlet being in fluid communication with the fluid source so that fluid from the fluid source can be supplied to the fluid passageway.

34. The actuator combination of claim 33 wherein the fluid passageway substantially encircles the conductor component.

35. The actuator combination of claim 33 wherein the circulation housing includes an outer shell and an inner shell that cooperate to define the fluid passageway.

36. The actuator combination of claim 35 wherein each shell substantially encircles the conductor.

37. The actuator combination of claim 33 wherein the circulation housing includes an inner shell that is secured to the magnet component, the inner shell cooperating with the magnet component to define the fluid passageway.

38. The actuator combination of claim 33 further comprising a control system that controls the flow of the fluid from the fluid source to the circulation housing to inhibit the transfer of heat from the conductor to the environment surrounding the actuator.

39. The actuator combination of claim 33 further comprising a control system that controls the flow of the fluid from the fluid source to the circulation housing to maintain an outer surface of the circulation housing at a predetermined temperature.

40. The actuator combination of claim 33 wherein the magnet component includes a pair of spaced apart magnet arrays and the conductor is positioned between the magnet arrays.

41. An isolation system including the actuator combination of claim 33.

42. A stage assembly including the actuator combination of claim 33.

43. An exposure apparatus including the actuator combination of claim 33.

44. An object on which an image has been formed by the exposure apparatus of claim 43.

45. A semiconductor wafer on which an image has been formed by the exposure apparatus of claim 43.

46. A method for circulating a fluid from a fluid source near an actuator, the actuator including a magnet component and a conductor component, the method comprising the steps of:
securing a circulation housing to the magnet component, the circulation housing providing a fluid passageway near the conductor component; and
directing the fluid from the fluid source through the fluid passageway.

47. The method of claim 46 wherein the step of securing the circulation housing includes the step of providing an outer shell and an inner shell that cooperate to define the fluid passageway, each shell substantially encircles the conductor component.

48. The method of claim 46 wherein the step of securing the circulation housing includes the step of providing an inner shell that cooperate with the magnet component to define the fluid passageway.

49. The method of claim 46 wherein the step of securing the circulation housing includes the step of substantially enclosing the conductor component with the circulation housing.

50. The method of claim 46 further comprising the step of controlling the rate of flow of the fluid from the fluid source to the circulation housing so that an outer surface of the circulation housing is maintained at a set temperature.

51. A method for making an isolation system comprising the steps of providing an actuator and circulating the fluid around the actuator pursuant to the method of claim 46.

52. A method for making a stage assembly comprising the steps of providing an actuator that moves a stage and circulating the fluid around the actuator pursuant to the method of claim 46.

53. A method for making an exposure apparatus comprising the steps of providing an actuator and circulating the fluid around the actuator pursuant to the method of claim 46.

54. A method of making a wafer utilizing the exposure apparatus made by the method of claim 53.

55. A method of making a device utilizing the exposure apparatus made by the method of claim 53.

56. A method for circulating a fluid from a fluid source near an actuator, the actuator including a magnet component and a conductor component, the method comprising the steps of:
positioning a circulation housing near the conductor component, the circulation housing providing a fluid passageway that substantially encircles the conductor component, the circulation housing including an end cap that distributes the fluid around the conductor component; and
directing the fluid from the fluid source into the end cap.

57. The method of claim 56 wherein the end cap includes an outer wall, an inner wall and a cavity between the outer wall and the inner wall, the inner wall having a width that is less than a width of the outer wall.

58. The method of claim 56 wherein the step of positioning the circulation housing includes the step of encircling the conductor component with an outer shell.

59. The method of claim 56 wherein the step of positioning the circulation housing includes the step of encircling the conductor component with a conductor housing that retains the conductor component and the step of encircling the conductor housing and the conductor component with an outer shell.

60. The method of claim 59 wherein the step of positioning the circulation housing includes the step of providing a plurality of supports that extend between the outer shell and the conductor housing to define the fluid passageway between the outer shell and the conductor housing.

61. The method of claim 59 wherein the step of positioning the circulation housing includes the step of providing a support that extends between the conductor housing and the end cap, the support coupling the conductor housing to the end cap.

62. The method of claim 56 further comprising the step of controlling the rate of flow of the fluid from the fluid source to the circulation housing so that an outer surface of the circulation housing is maintained at a set temperature.

63. A method for making an isolation system comprising the steps of providing an actuator and circulating the fluid around the actuator pursuant to the method of claim 56.

64. A method for making a stage assembly comprising the steps of providing an actuator that moves a stage and circulating the fluid around the actuator pursuant to the method of claim 56.

65. A method for making an exposure apparatus comprising the steps of providing an actuator and circulating the fluid around the actuator pursuant to the method of claim 56.

66. A method of making a wafer utilizing the exposure apparatus made by the method of claim 65.

67. A method of making a device utilizing the exposure apparatus made by the method of claim 65.

68. A method for making an actuator combination for use with a fluid source including a fluid, the method comprising the steps of:
providing an actuator including a magnet component and a conductor component, the conductor component having a conductor;
positioning a circulation housing having fluid passageway near the conductor, the circulation housing being fixedly secured to the magnet component; and
connecting the fluid source to the fluid passageway.

69. The method of claim 68 wherein the step of positioning the circulation housing includes the step of providing an outer shell and an inner shell that cooperate to define the fluid passageway, each shell substantially encircles the conductor.

70. The method of claim 68 wherein the step of positioning the circulation housing includes the step of providing an inner shell that cooperate with the magnet component to define the fluid passageway.

71. A method for making an isolation system including the step of providing an actuator combination made by the method of claim 68.

72. A method for making a stage assembly including the step of providing an actuator combination made by the method of claim 68.

73. A method for making an exposure apparatus that forms an image on an object, the method comprising the steps of:
providing an irradiation apparatus that irradiates the object with radiation to form the image on the object; and
providing an actuator combination made by the method of claim 68.

74. A method of making a wafer utilizing the exposure apparatus made by the method of claim 73.

75. A method of making a device utilizing the exposure apparatus made by the method of claim 73.

76. An actuator combination for use with a fluid source including a fluid, the actuator combination comprising:
a magnet component;
a conductor component including a conductor, the conductor component interacts with the magnet component to generate driving force that generates relative motion between the magnet component and the conductor component; and
a fluid passageway positioned near the conductor and connected to the fluid source, the fluid passageway is movable relative to the conductor component.
